(19) United States
(12) Patent Application Publication
(10) Pub. No.: US 2015/0181571 A1
(43) Pub. Date: Jun. 25, 2015

(54) METHOD MONITORING PDCCH BASED ON DRX AND COMMUNICATION DEVICE THEREOF

(71) Applicant: LG ELECTRONICS INC., Seoul (KR)

(72) Inventors: Sungjun Park, Seoul (KR); Youngdae Lee, Seoul (KR); Seungjune Yi, Seoul (KR); Sunghoon Jung, Seoul (KR); Sunyoung Lee, Seoul (KR)

(73) Assignee: LG ELECTRONICS INC., Seoul (KR)

(21) Appl. No.: 14/414,070

(22) PCT Filed: Jul. 19, 2013
(86) PCT No.: PCT/KR2013/006508

§ 371 Date: Jan. 9, 2015

Related U.S. Application Data
(60) Provisional application No. 61/683,220, filed on Aug. 15, 2012.

(51) Int. Cl. H04W 72/04; H04W 76/04; H04W 72/12; H04W 24/08

(52) U.S. Cl. CPC H04W 72/042; H04W 24/08; H04W 76/048; H04W 72/1268

(57) ABSTRACT

There is provided a monitoring method according to a discontinuous reception (DRX), the method comprising: determining whether an uplink data to be retransmitted is related to a semi-persistent scheduling (SPS); and monitoring a physical downlink control channel (PDCCH) to receive an uplink grant for the retransmission if the uplink data to be retransmitted is not related to the SPS, or not monitoring the PDDCH, if the uplink data to be retransmitted is related to the SPS.

### TECHNICAL FIELD

The present invention relates to wireless communication, and more specifically, to a method monitoring physical downlink control channel (PDCCH) based on a discontinuous reception (DRX) and communication device thereof in a wireless communication system.

### BACKGROUND ART

3rd generation partnership project (3GPP) long term evolution (LTE) is an improved version of a universal mobile telecommunication system (UMTS) and is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas. In recent years, there is an ongoing discussion on 3GPP LTE-advanced (LTE-A) that is an evolution of the 3GPP LTE.

Examples of techniques employed in the 3GPP LTE-A include carrier aggregation.

The carrier aggregation uses a plurality of component carriers. The component carrier is defined with a center frequency and a bandwidth. One downlink component carrier or a pair of an uplink component carrier and a downlink component carrier is mapped to one cell. When a user equipment receives a service by using a plurality of downlink component carriers, it can be said that the user equipment receives the service from a plurality of serving cells. That is, the plurality of serving cells provide a user equipment with various services.

Meanwhile, a discontinuous reception (DRX) cycle specifies the periodic repetition of the on-duration followed by a possible period of inactivity. The DRX cyclic includes an on-duration and an off-duration. The on-duration is a duration in which a UE monitors a PDCCH within the DRX cycle.

An Active Time can include an on-duration in which the PDCCH is periodically monitored and a duration in which the PDCCH is monitored due to an event occurrence.

The Active Time includes the time when an uplink grant for a pending HARQ retransmission or an adaptive retransmission can occur and there is data in the corresponding HARQ buffer.

### DISCLOSURE OF THE INVENTION

In the related art as above explained, the on-duration is a duration in which a UE monitors a PDCCH within the DRX cycle. However although the UE receives the HARQ ACK, there is a problem in that the UE is required to monitor the PDCCH due to a possibility to receive an instruction of adaptive retransmission.

Therefore, an object of the present invention is to provide a solution to the above-described problem.

To achieve these and other advantages and in accordance with the purpose of the present invention, as embodied and broadly described herein, there is provided a monitoring method according to a discontinuous reception (DRX), the method comprising: determining whether an uplink data to be retransmitted is related to a semi-persistent scheduling (SPS); and monitoring a physical downlink control channel (PDCCH) to receive an uplink grant for the retransmission if the uplink data to be retransmitted is not related to the SPS, or not monitoring the PDDCH, if the uplink data to be retransmitted is related to the SPS.

To achieve these and other advantages and in accordance with the purpose of the present invention, as embodied and broadly described herein, there is also provided a communication device configured for monitoring physical downlink control channel (PDCCH) according to a discontinuous reception (DRX), the communication device comprising: a processor configured to determine whether an uplink data to be retransmitted is related to a semi-persistent scheduling (SPS); and a radio frequency unit configured to monitor a physical downlink control channel (PDCCH) to receive an uplink grant for the retransmission if the uplink data to be retransmitted is not related to the SPS, or not monitor the PDDCH, if the uplink data to be retransmitted is related to the SPS.

In the determination, if an initial transmission of the uplink data was performed on a resource configured for the SPS, it may be determined that the uplink data to be retransmitted is related to the SPS. Also, in the determination, if the SPS is not setup, it may be determined that the uplink data to be retransmitted is not related to a SPS.

wherein in the determination, if an initial transmission of the uplink data was performed on a resource which is not configured for the SPS, it may be determined that the uplink data to be retransmitted is not related to a SPS.

The method may further comprise performing an initial transmission of the uplink data.

The method may further comprise determining whether the uplink data to be retransmitted is pending in a buffer.

The monitoring step may include: considering a duration to receive the uplink grant for the retransmission as an active time in order to monitor the PDCCH, if the uplink data to be retransmitted is not related to the SPS.

The not monitoring step may include: not considering a duration to receive the uplink grant for the retransmission as an active time in order not to monitor the PDCCH, if the uplink data to be retransmitted is related to the SPS.

According to the present specification, if the HARQ retransmission is related to the persistent scheduling, there is provided a way or method for allowing the UE not to consider a duration or time to receive the uplink grant for the retransmission of data as an active time in order not to monitor the PDCCH. Accordingly, wastingly consuming the battery of the UE to monitor unnecessarily the PDCCH is prevented.

### BRIEF DESCRIPTION OF THE DRAWINGS

FIG. 1 shows a wireless communication system to which the present invention is applied.

FIG. 2 is a block diagram showing functional split between the E-UTRAN and the EPC.

FIG. 3 is a diagram showing a radio protocol architecture for a user plane.

FIG. 4 is a diagram showing a radio protocol architecture for a control plane.

FIG. 5 shows a DRX cycle.

FIG. 6 shows active time at 3GPP LTE.

FIG. 7 shows an example of a transition of a DRX cycle.

FIG. 8 shows a semi-persistent scheduling method (SPS) in 3GPP LTE.

FIG. 9 is an exemplary view illustrating a dynamic radio resource scheduling.

FIG. 10 shows some exemplary HARQ operations between the eNB and UE.

FIG. 11 shows some exemplary operation of the UE according to one embodiment disclosed in the present specification.

FIG. 12 shows one example of the C-RNTI MAC control element.

FIG. 13 is a block diagram showing a wireless communication system to implement an embodiment of the present invention.

### MODES FOR CARRYING OUT THE PREFERRED EMBODIMENTS

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Description will now be given in detail of a drain device and a refrigerator having the same according to an embodiment, with reference to the accompanying drawings.

The present invention will be described on the basis of a universal mobile telecommunication system (UMTS) and an evolved packet core (EPC). However, the present invention is not limited to such communication systems, and it may be also applicable to all kinds of communication systems and methods to which the technical spirit of the present invention is applied.

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the spirit of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

The terms used herein including an ordinal number such as first, second, etc. can be used to describe various elements, but the elements should not be limited by those terms. The terms are used merely to distinguish an element from the other element. For example, a first element may be named to a second element, and similarly, a second element may be named to a first element.

In case where an element is “connected” or “linked” to the other element, it may be directly connected or linked to the other element, but another element may be existed therebetween. On the contrary, in case where an element is “directly connected” or “directly linked” to another element, it should be understood that any other element is not existed therebetween.

Hereinafter, preferred embodiments of the present invention will be described in detail with reference to the accompanying drawings, and the same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings. The spirit of the invention should be construed as being extended even to all changes, equivalents, and substitutes other than the accompanying drawings.

There is an exemplary UE (User Equipment) in accompanying drawings, however the UE may be referred to as terms such as a terminal, a mobile equipment (ME), a mobile station (MS), a user terminal (UT), a subscriber station (SS), a wireless device (WD), a handheld device (HD), an access terminal (AT), and etc. And, the UE may be implemented as a portable device such as a notebook, a mobile phone, a PDA, a smart phone, a multimedia device, etc, or as an unportable device such as a PC or a vehicle-mounted device.

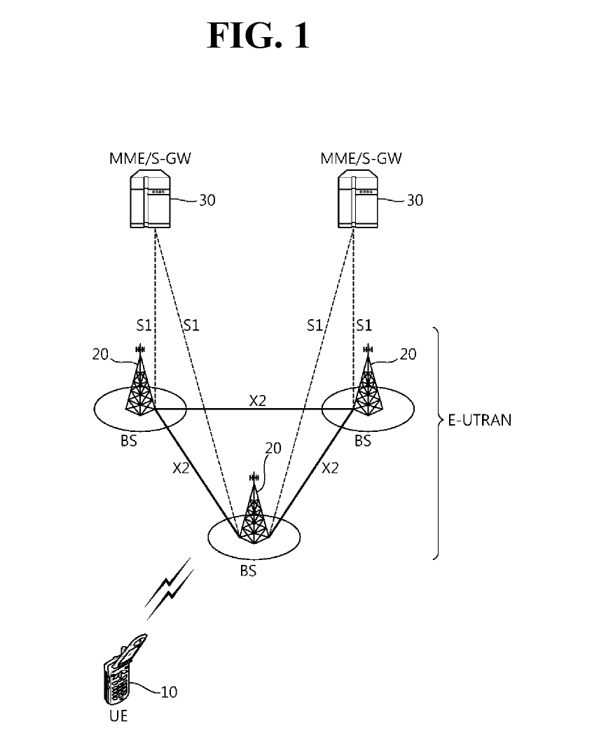

FIG. 1 shows a wireless communication system to which the present invention is applied.

The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

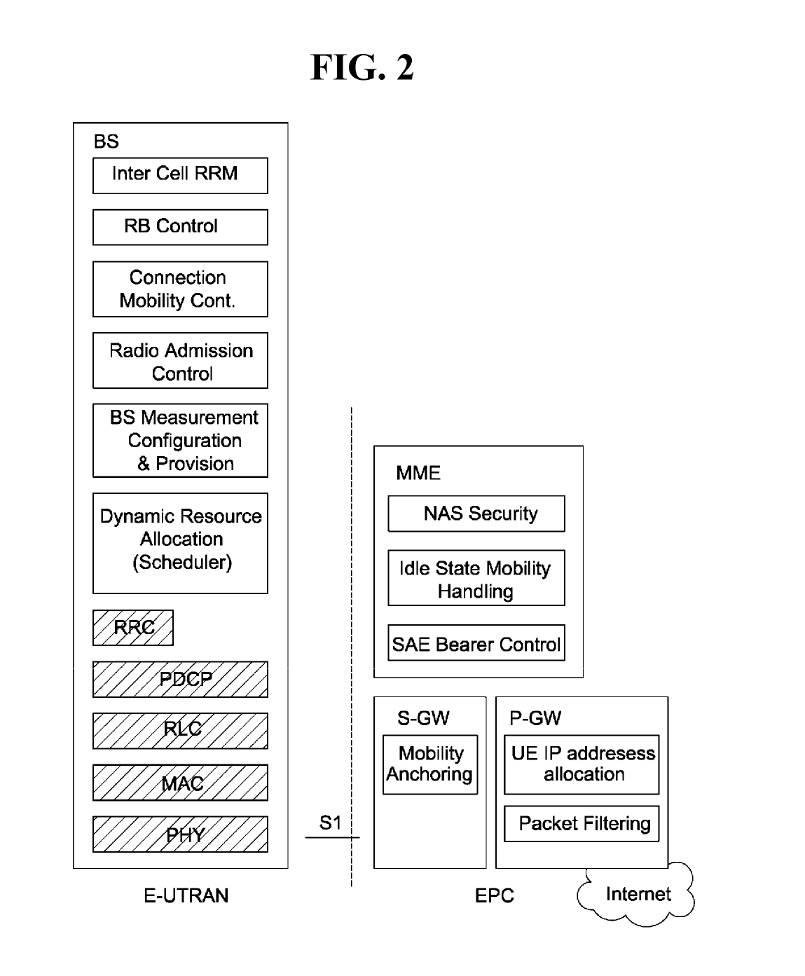

FIG. 2 is a block diagram showing functional split between the E-UTRAN and the EPC.

Slashed boxes depict radio protocol layers and white boxes depict the functional entities of the control plane. Referring to FIG. 2, a BS performs the following functions. (1) Functions for Radio Resource Management such as Radio Bearer Control, Radio Admission Control, Connection Mobility Control, Dynamic allocation of resources to UEs in both uplink and downlink (scheduling), (2) IP (Internet Protocol) header compression and encryption of user data stream, (3) Routing of User Plane data towards S-GW, (4) Scheduling and transmission of paging messages, (5) Scheduling and transmission of broadcast information, and (6) Measurement and measurement reporting configuration for mobility and scheduling.

The MME hosts the following functions. (1) NAS (Non-Access Stratum) signaling, (2) NAS signaling security, (3) Idle mode UE Reachability, (4) Tracking Area list management, (5) Roaming, (6) Authentication. The S-GW hosts the following functions. (1) Mobility anchoring, (2) lawful interception.

The PDN gateway (P-GW) hosts the following functions. (1) UE IP (internet protocol) allocation, (2) packet filtering.

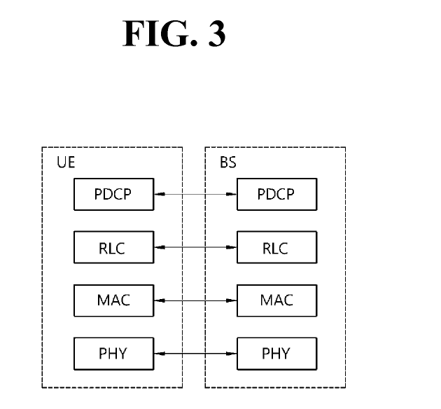

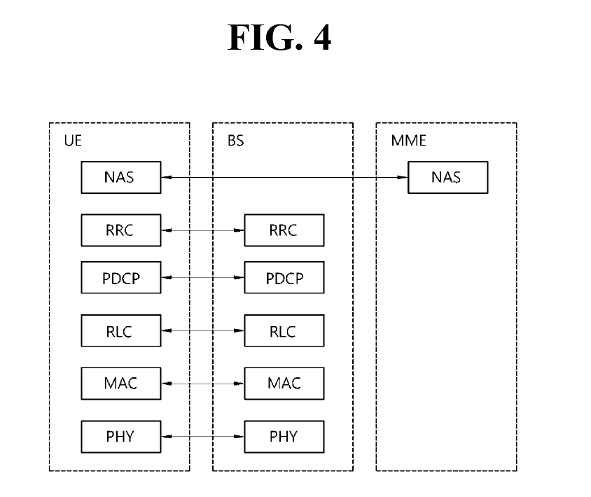

FIG. 3 is a diagram showing a radio protocol architecture for a user plane. FIG. 4 is a diagram showing a radio protocol architecture for a control plane.

The user plane is a protocol stack for user data transmission. The control plane is a protocol stack for control signal transmission.

Referring to FIGS. 3 and 4, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Between different PHY layers, i.e., a PHY layer of a transmitter and a PHY layer of a receiver, data is transferred through the physical channel. The physical channel may be modulated using an orthogonal frequency division multiplexing (OFDM) scheme, and may utilize time and frequency as a radio resource.

Functions of the MAC layer include mapping between a logical channel and a transport channel and multiplexing/de-multiplexing on a transport block provided to a physical channel over a transport channel of a MAC service data unit (SDU) belonging to the logical channel. The MAC layer provides a service to a radio link control (RLC) layer through the logical channel.

Functions of the RLC layer include RLC SDU concatenation, segmentation, and reassembly. To ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides error correction by using an automatic repeat request (ARQ).

Functions of a packet data convergence protocol (PDCP) layer in the user plane include user data delivery, header compression, and ciphering. Functions of a PDCP layer in the control plane include control-plane data delivery and ciphering/integrity protection.

A radio resource control (RRC) layer is defined only in the control plane. The RRC layer serves to control the logical channel, the transport channel, and the physical channel in association with configuration, reconfiguration and release of radio bearers (RBs). An RB is a logical path provided by the first layer (i.e., the PHY layer) and the second layer (i.e., the MAC layer, the RLC layer, and the PDCP layer) for data delivery between the UE and the network.

The setup of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the network, the UE is in an RRC connected state (also may be referred as an RRC connected mode), and otherwise the UE is in an RRC idle state (also may be referred as an RRC idle mode).

Data is transmitted from the network to the UE through a downlink transport channel. Examples of the downlink transport channel include a broadcast channel (BCH) for transmitting system information and a downlink-shared channel (SCH) for transmitting user traffic or control messages. The user traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several subcarriers in a frequency domain. One subframe includes a plurality of OFDM symbols in the time domain. A resource block is a resource allocation unit, and includes a plurality of OFDM symbols and a plurality of subcarriers. Further, each subframe may use particular subcarriers of particular OFDM symbols (e.g., a first OFDM symbol) of a corresponding subframe for a physical downlink control channel (PDCCH), i.e., an L1/L2 control channel. A transmission time interval (TTI) is a unit time of subframe transmission.

Hereinafter, an RRC state of a UE and an RRC connection mechanism will be described.

The RRC state indicates whether an RRC layer of the UE is logically connected to an RRC layer of an E-UTRAN. If the two layers are connected to each other, it is called an RRC connected state, and if the two layers are not connected to each other, it is called an RRC idle state. When in the RRC connected state, the UE has an RRC connection and thus the E-UTRAN can recognize a presence of the UE in a cell unit. Accordingly, the UE can be effectively controlled. On the other hand, when in the RRC idle state, the UE cannot be recognized by the E-UTRAN, and is managed by a core network in a tracking area unit which is a unit of a wider area than a cell. That is, regarding the UE in the RRC idle state, only a presence or absence of the UE is recognized in a wide area unit. To get a typical mobile communication service such as voice or data, a transition to the RRC connected state is necessary.

When a user initially powers on the UE, the UE first searches for a proper cell and thereafter stays in the RRC idle state in the cell. Only when there is a need to establish an RRC connection, the UE staying in the RRC idle state establishes the RRC connection with the E-UTRAN through an RRC connection procedure and then transitions to the RRC connected state. Examples of a case where the UE in the RRC idle state needs to establish the RRC connection are various, such as a case where uplink data transmission is necessary due to telephony attempt of the user or the like or a case where a response message is transmitted in response to a paging message received from the E-UTRAN.

A non-access stratum (NAS) layer belongs to an upper layer of the RRC layer and serves to perform session management, mobility management, or the like.

To manage mobility of the UE in the NAS layer, two states are defined, i.e., an EPS mobility management-REGISTERED (EMM-REGISTERED) state and an EMM-DEREGISTERED state. These two states apply to the UE and the MME. Initially, the UE is in the EMM-DEREGISTERED state. To access a network, the UE performs a process of registering to the network through an initial attach procedure. If the attach procedure is successfully performed, the UE and the MME enter the EMM-REGISTERED state.

To manage a signaling connection between the UE and the EPC, two states are defined, i.e., an EPS connection management (ECM)-IDLE state and an ECM-CONNECTED state. These two states apply to the UE and the MME. When the UE in the ECM-IDLE state establishes an RRC connection with the E-UTRAN, the UE enters the ECM-CONNECTED state. When the MME in the ECM-IDLE state establishes an S1 connection with the E-UTRAN, the MME enters the ECM-CONNECTED state. When the UE is in the ECM-IDLE state, the E-UTRAN does not have context information of the UE. Therefore, the UE in the ECM-IDLE state performs a UE-based mobility related procedure such as cell selection or reselection without having to receive a command of the network. On the other hand, when the UE is in the ECM-CONNECTED state, mobility of the UE is managed by the command of the network. If a location of the UE in the ECM-IDLE state becomes different from a location known to the network, the UE reports the location of the UE to the network through a tracking area update procedure.

Next, system information will be described.

The system information includes essential information that must be known to a UE to access a BS. Thus, the UE has to receive all of the system information before accessing the BS. Further, the UE must always have the latest system information. Since the system information is information that must be known to all UEs in one cell, the BS periodically transmits the system information.

According to the section 5.2.2 of 3GPP TS 36.331 V8.4.0 (2008-12) “Radio Resource Control (RRC); Protocol specification (Release 8)”, the system information is classified into a master information block (MIB), a scheduled block (SB), and a system information block (SIB). The MIB allows the UE to know a physical configuration (e.g., bandwidth) of a particular cell. The SB reports transmission information (e.g., a transmission period or the like) of SIBs. The SIB is a group of a plurality of pieces of system information related to each other. For example, an SIB includes only information of a neighbor cell, and another SIB includes only information of an uplink radio channel used by the UE.

In general, a service provided by the network to the UE can be classified into three types to be described below. Further, according to which service can be provided, the UE recognizes a cell type differently. A service type will be first described below, and then the cell type will be described.

1) Limited service: This service provides an emergency call and an earthquake and tsunami warning system (ETWS), and can be provided in an acceptable cell.

2) Normal service: This service denotes a public use service for general use, and can be provided in a suitable or normal cell.

3) Operator service: This service denotes a service for a network service provider, and a cell can be used only by the network service provider and cannot be used by a normal user.

The service type provided by a cell can be classified as follows.

1) Acceptable cell: This cell serves a UE with a limited service. This cell is not barred from the perspective of the UE, and satisfies a cell selection criterion of the UE.

2) Suitable cell: This cell serves a UE with a regular service. This cell satisfies a condition of the acceptable cell, and also satisfies additional conditions. Regarding the additional conditions, this cell has to belong to a PLMN to which the UE can access, and a tracking area update procedure of the UE must not be barred in this cell. If the corresponding cell is a CSG cell, this cell must be accessible by the UE as a CSG member.

3) Barred cell: Information indicating that a cell is a barred cell is broadcast in this cell by using the system information.

4) Reserved cell: Information indicating that a cell is a reserved cell is broadcast in this cell by using the system information.

Now, a radio link failure will be described.

A UE persistently performs measurement to maintain quality of a radio link with a serving cell from which the UE receives a service. The UE determines whether communication is impossible in a current situation due to deterioration of the quality of the radio link with the serving cell. If it is determined that the quality of the serving cell is so poor that communication is almost impossible, the UE determines the current situation as a radio link failure.

If the radio link failure is determined, the UE gives up maintaining communication with the current serving cell, selects a new cell through a cell selection (or cell reselection) procedure, and attempts RRC connection re-establishment to the new cell.

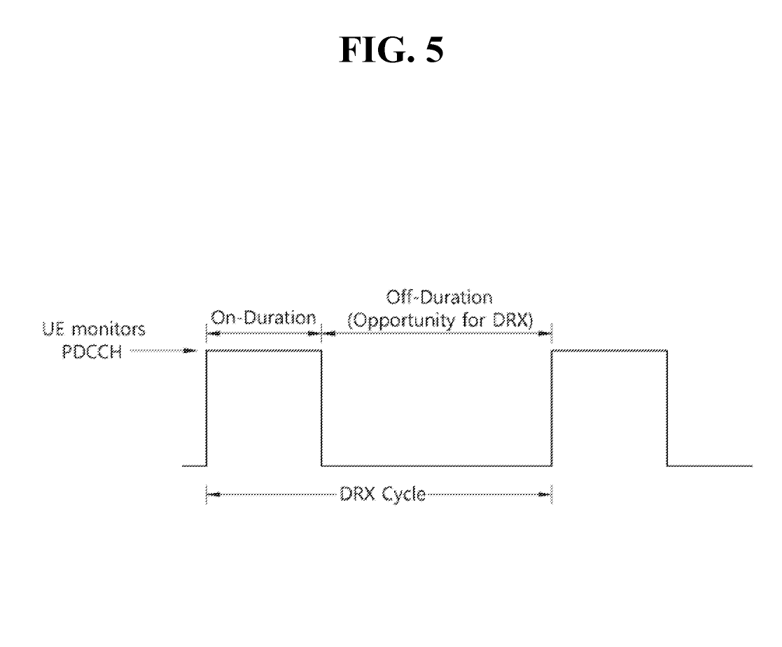

FIG. 5 shows a DRX cycle.

A discontinuous reception (DRX) cycle specifies the periodic repetition of the on-duration followed by a possible period of inactivity. The DRX cyclic includes an on-duration and an off-duration. The on-duration is a duration in which a UE monitors a PDCCH within the DRX cycle.

When the DRX is configured, the UE may monitor the PDCCH only in the on-duration and may not monitor the PDCCH in the off-duration.

An on Duration timer is used to define the on-duration. The on-duration can be defined as a duration in which the on Duration timer is running. The on Duration timer may specify the number of consecutive PDCCH-subframe(s) at the beginning of a DRX Cycle. The PDCCH-subframe specifies a subframe in which the PDCCH is monitored.

In addition to the DRX cycle, a duration in which the PDCCH is monitored can be further defined. A duration in which the PDCCH is monitored is collectively referred to as an active time.

A drx-Inactivity timer deactivates the DRX. If the drx-Inactivity timer is running, the UE continuously monitors the PDCCH irrespective of the DRX cycle. The drx-Inactivity timer starts upon receiving an initial UL grant or DL grant on the PDCCH. The drx-Inactivity timer may specify the number of consecutive PDCCH-subframe(s) after successfully decoding a PDCCH indicating an initial UL or DL user data transmission for this UE.

A HARQ RTT timer defines a minimum duration in which the UE expects HARQ retransmission. The HARQ RTT timer may specify the minimum amount of subframe(s) before a DL HARQ retransmission is expected by the UE.

A drx-Retransmission timer defines a duration in which the UE monitors the PDCCH while expecting DL retransmission. The drx-Retransmission timer may specify the maximum number of consecutive PDCCH-subframe(s) for as soon as a DL retransmission is expected by the UE. After initial DL transmission, the UE starts the HARQ RTT timer. When an error is detected for the initial DL transmission, the UE transmits NACK to a BS, stops the HARQ RTT timer, and runs the drx-Retransmission timer. The UE monitors the PDCCH for DL retransmission from the BS while the drx-Retransmission timer is running.

An Active Time can include an on-duration in which the PDCCH is periodically monitored and a duration in which the PDCCH is monitored due to an event occurrence.

When a DRX cycle is configured, the Active Time includes the time while:
on Duration timer or drx-Inactivity timer or drx-Retransmission timer or mac-ContentionResolution timer is running; or
a Scheduling Request is sent on PUCCH and is pending; or
an uplink grant for a pending HARQ retransmission or an adaptive retransmission can occur and there is data in the corresponding HARQ buffer; or
a PDCCH indicating a new transmission addressed to the C-RNTI of the UE has not been received after successful reception of a Random Access Response for the preamble not selected by the UE.

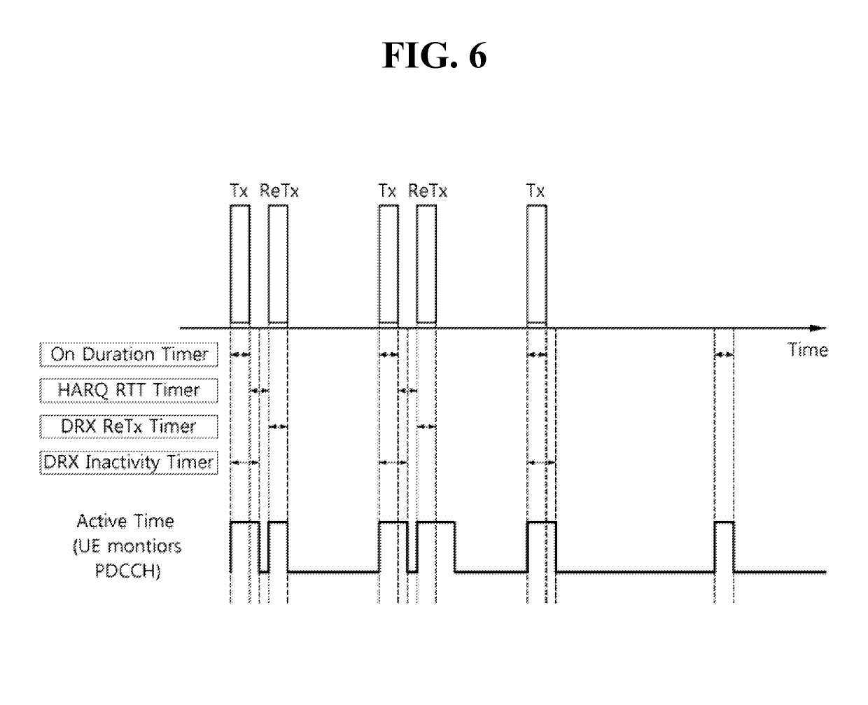

FIG. 6 shows active time at 3GPP LTE.

When DRX is configured, the UE shall for each subframe:
if a HARQ RTT Timer expires in this subframe and the data of the corresponding HARQ process was not successfully decoded:
   start the drx-Retransmission timer for the corresponding HARQ process.
if a DRX Command MAC CE (control element) is received:
   stop on Duration timer and drx-Inactivity timer.
if drx-InactivityTimer expires or a DRX Command MAC CE is received in this subframe:
   if the Short DRX cycle is configured:
      start or restart drx-ShortCycle timer and use the Short DRX Cycle.
   else:
      use the Long DRX cycle.
if drx-ShortCycle timer expires in this subframe:
   use the Long DRX cycle.
If the Short DRX Cycle is used and [(SFN*10)+subframe number] modulo (shortDRX-Cycle)=(drxStartOffset) modulo (shortDRX-Cycle); or
if the Long DRX Cycle is used and [(SFN*10)+subframe number] modulo (longDRX-Cycle)=drxStartOffset:
   start on Duration timer.
during the Active Time, for a PDCCH-subframe, if the subframe is not required for uplink transmission for half-duplex FDD UE operation and if the subframe is not part of a configured measurement gap:
   monitor the PDCCH;
   if the PDCCH indicates a DL transmission or if a DL assignment has been configured for this subframe:
      start the HARQ RTT timer for the corresponding HARQ process;
      stop the drx-Retransmission timer for the corresponding HARQ process.
   if the PDCCH indicates a new transmission (DL or UL):
      start or restart drx-Inactivity timer.

The DRX cycle has two types, i.e., a long DRX cycle and a short DRX cycle. The long DRX cycle which has a long period can minimize battery consumption of the UE. The short DRX cyclic which has a short period can minimize a data transmission delay.

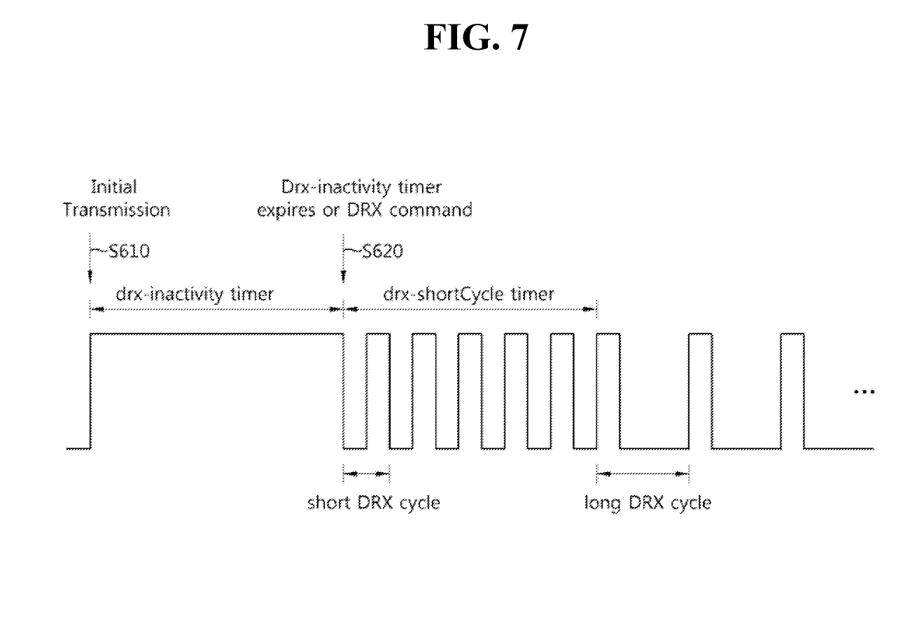

FIG. 7 shows an example of a transition of a DRX cycle.

Upon receiving initial transmission from an eNB, a drx-Inactivity timer (also referred to as a first timer or an inactivity timer) starts (step S610). A UE continuously monitors a PDCCH while the drx-Inactivity timer is running.

If the drx-Inactivity timer expires or if a DRX command is received from the eNB, the UE transitions to a short DRX cycle (step S620). Then, the drx-shortCycle timer (also referred to as a second timer or a DRX cycle timer) starts.

The DRX command can be transmitted as a MAC CE, and can be called a DRX indicator that indicates a transition to the DRX. The DRX command MAC CE is identified through a long channel ID (LCID) of a MAC PDU subheader.

While the drx-shortCycle timer is running, the UE operates in the short DRX cycle. If the drx-shortCycle timer expires, the UE transitions to a long DRX cycle.

If the short DRX cyclic is pre-set, the UE transitions to the short DRX cycle. If the short DRX cyclic is not pre-set, the UE can transition to the long DRX cycle.

A value of HARQ RTT timer is fixed to 8 ms (or 8 subframes). Other timer values (i.e., an on Duration timer, a drx-Inactivity timer, a drx-Retransmission timer, a mac-ContentionResolution timer, etc.) can be determined by the eNB through an RRC message. The eNB can configure the long DRX cycle and the short DRX cycle through the RRC message.

In the above process, the DRX command MAC CE is a MAC CE used when the eNB commands the UE to transition to a DRX state. As shown in the above process, upon receiving the DRX command MAC CE from the eNB, if the short DRX cycle is configured, the UE transitions to a short DRX state, and otherwise transitions to a long DRX state.

The long DRX cycle and the short DRX cycle are for exemplary purposes only, and thus an additional DRX cycle can be configured.

Recently, many applications require an always-on characteristic. Always-on is a characteristic in which the UE is always connected to a network so as to directly transmit data whenever necessary.

However, since battery consumption is great when the UE continuously maintains the network connection, a proper DRX is configured in a corresponding application to guarantee the always-on characteristic while reducing battery consumption.

Recently, several various applications are running in parallel in one UE, and thus it is not easy to configure one DRX suitable for all of the applications. This is because, even if an optimal DRX is configured for a specific application, it may be a not proper DRX configuration with respect to other applications which are running in parallel.

A method for operating the DRX in a more flexible manner is required in an environment in which various applications are used.

In order to optimize battery consumption of the UE, it is proposed to configure a plurality of DRX patterns by the UE.

The DRX pattern may include a DRX cycle. Alternatively, the DRX pattern may include only an on-duration which is a duration in which a PDCCH is monitored.

The DRX pattern may be configured per DRB. The DRX pattern may depend on a traffic characteristic of DRB.

The DRX pattern may be configured per carrier or per serving cell.

When the eNB sets the DRB to the UE, the eNB can provide a DRX pattern related to the DRB. The DRX pattern can be identified by a DRX pattern ID. The DRX pattern ID can be reported by the eNB to the UE.

Hereinafter, a scheduling mode will be explained.

The scheduling mode can be classified into a dynamic scheduling mode and a persistent or semi-persistent scheduling mode. The dynamic scheduling mode is to transmit scheduling information to a specific user equipment through the PDCCH whenever allocation of uplink or downlink resources is required for the specific user equipment. The persistent scheduling mode means that the eNB allocates downlink or uplink scheduling information to the user equipment statically during initial call establishment such as establishment of a radio bearer.

In case of the persistent scheduling mode, the user equipment transmits or receives data using scheduling information previously allocated to the eNB without using DL scheduling information or UL scheduling information allocated from the eNB. For example, if the eNB previously sets a specific user equipment to allow the user equipment to receive downlink data through RRC signal and a radio resource “A” in accordance with a transport format “B” and a period “C” during establishment of a radio bearer, the user equipment can receive downlink data transmitted from the eNB using information “A”, “B” and “C”. Likewise, even in case that the user equipment transmits data to the eNB, the user equipment can transmit uplink data using a previously defined radio resource in accordance with previously allocated uplink scheduling information. The persistent scheduling mode is a scheduling mode that can well be applied to a service of which traffic is regular, such as voice communication.

AMR codec used in voice communication, i.e., voice data generated through voice codec has a special feature. Namely, voice data are classified into a talk spurt and a silent period. The talk spurt means a voice data period generated while a person is actually talking, and the silent period means a voice data period generated while a person does not talk. For example, voice packets, which include voice data in the talk spurt, are generated per 20 ms, and silent packets (SID), which include voice data in the silent period, are generated per 160 ms.

If the persistent scheduling mode is used for voice communication, the eNB will establish radio resources in accordance with the talk spurt. Namely, the eNB will previously establish radio resources for transmitting and receiving uplink or downlink data to and from the user equipment at an interval of 20 ms during call establishment using a feature that voice packets are generated per 20 ms. The user equipment receives downlink data or transmits uplink data using radio resources, which are previously established per 20 ms.

Hereinafter, a semi-persistent scheduling (SPS) method and a dynamic scheduling method will be explained in more detail.

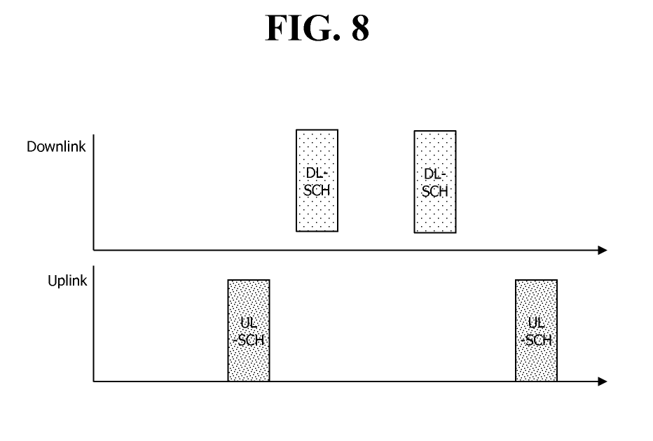

FIG. 8 shows a semi-persistent scheduling method (SPS) in 3GPP LTE.

The SPS uses a modulation and coding scheme (MCS) or resource allocation determined according to a predetermined period, in order to transmit a specific amount of traffic such as voice over Internet protocol (VoIP) with a specific period. Although a UL SPS case is shown herein, the same also applies to a DL SPS case.

In general, the UE transmits data to the base station through the process including: 1) the UE requests radio resources required for transmitting generated data from the base station, 2) the base station allocates radio resources through a control signal according to the UE request for radio resources, and 3) the UE transmits the data to the base station through the allocated radio resources. However, in the VoIP service, in general, small packets of uniform size are frequently and regularly transmitted. So, the effective radio resource allocation scheme can be applied in consideration of such characteristics. Namely, the semi-permanent scheduling is also one of radio resource allocation schemes optimized for a VoIP service. In this method, transmission of information regarding allocation of radio resources is omitted. In more detail, when VoIP starts, a packet size and period of RTP are previously determined and radio resources are permanently allocated. Accordingly, the UE may immediately perform the process of transmitting data without the first and second steps, namely, without the radio resource requesting step and the radio resource allocation step, as mentioned above, according to such setting of resource resources. That is, in the semi-persistent scheduling, there is no need to transmit radio resource allocation information via a PDCCH. Without receiving the PDCCH each time, the UE can periodically receive particular radio resources or transmit data by using particular radio resources according to pre-set information.

Meanwhile, the dynamic scheduling is a method for informing about radio resources to be received or to be transmitted by the UE each time.

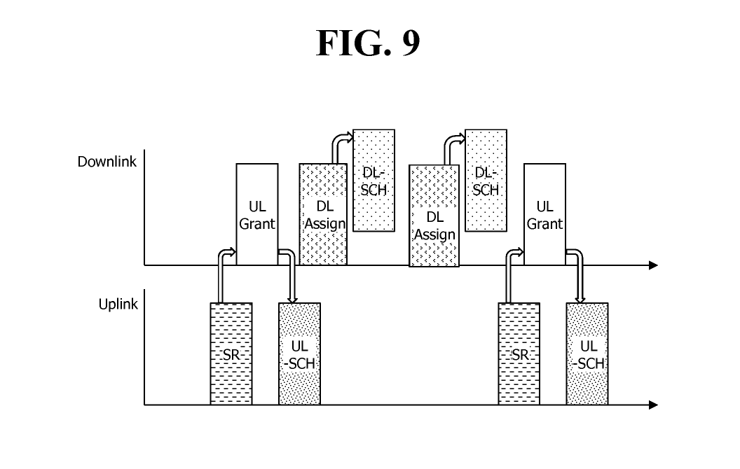

FIG. 9 is an exemplary view illustrating a dynamic radio resource scheduling.

As shown in FIG. 9, according to a dynamic radio resource allocation method for the uplink, the UE transmits a scheduling request (SR) for requesting radio resources to the base station, and accordingly, the base station transmits an uplink (UL) grant for an uplink radio resource via PDCCH. Accordingly, the UE uplink data via the UL-SCH is transmitted to the base station. For downlink, the base station assigns the downlink (DL) radio resource and then transmits the PDCCH including downlink radio resource information to the UE. Thus, the base station transmits downlink data via DL-SCH to the UE.

Hereinafter, a hybrid automatic repeat request (HARQ) will be explained

According to the HARQ scheme, whether unrecoverable errors are included in data received by a physical layer is determined, and retransmission is requested when an error occurs, thereby improving performance.

A HARQ-based retransmission scheme can be classified into a synchronous HARQ and an asynchronous HARQ. The synchronous HARQ is a scheme in which data is retransmitted at a time point known to a transmitter and a receiver. In the synchronous HARQ, signaling such as a HARQ processor number can be omitted. The asynchronous HARQ is a scheme in which resources for retransmission are allocated at an arbitrary time point. In the asynchronous HARQ, an overhead occurs due to an extra signaling.

According to a transmission attribute, the HARQ can be also classified into an adaptive HARQ and a non-adaptive HARQ. The transmission attribute includes resource allocation, a modulation scheme, a transport block size, etc. In the adaptive HARQ, depending on changes in a channel condition, transmission attributes are entirely or partially changed. In the non-adaptive HARQ, the transmission attributes used for the first transmission are persistently used irrespective of the changes in the channel condition.

When no error is detected from received data, the receiver transmits an acknowledgement (ACK) signal as a response signal and thus informs the transmitter of successful reception. When an error is detected from the received data, the receiver transmits a negative-acknowledgement (NACK) signal as the response signal, and thus informs the transmitter of error detection. The transmitter can retransmit the data upon receiving the NACK signal.

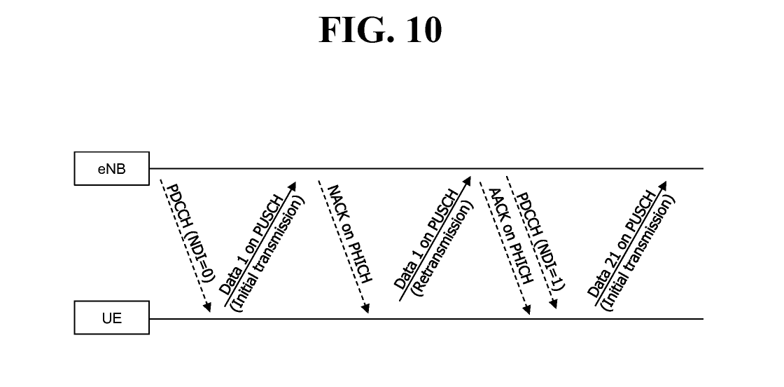

FIG. 10 shows some exemplary HARQ operations between the eNB and UE.

In FIG. 10, description will be given in an uplink state in which a UE is a transmission side, a base station (eNode B or eNB) is a reception side, and HARQ feedback information is received from the base station, but may be equally applied to downlink transmission.

First, the eNB may transmit uplink scheduling information, that is, uplink grant (UL grant), via a Physical Downlink Control channel (PDCCH), in order to enable the UE to transmit data using the HARQ scheme. The UL grant may include a UE identifier (e.g., C-RNTI, semi-persistent scheduling C-RNTI), a location of an assigned radio resource (resource block assignment), a transmission parameter such as a modulation/coding rate, a redundancy version and the like, a new data indicator (NDI), etc.

The UE may check UL grant information sent to itself by monitoring a PDCCH in each Transmission Time Interval (TTI). In case of discovering the UL grant information sent to itself, the UE may initially transmit data (data 1 in FIG. 10) via a physical uplink shared channel (PUSCH) according to the received UL grant information. In this case, the transmitted data can be transmitted by a MAC Protocol Data Unit (PDU).

As described above, after the UE has performed the uplink transmission via the PUSCH, the UE waits for reception of HARQ feedback information via a Physical Hybrid-ARQ Indicator Channel (PHICH) from the eNB. If HARQ NACK for the data 1 is transmitted from the eNB, the UE retransmits the data 1 in a retransmission TTI of the data 1. On the contrary, if HARQ ACK is received from the eNB (not shown), the UE stops the HARQ retransmission of the data 1.

Meanwhile, after the UE has performed the initial uplink transmission, the UE also needs to monitor the PDCCH, since the eNB may require an adaptive retransmission. In case of FIG. 10, since the UE receives the HARQ NACK and does not receives PDCCH for the adaptive retransmission, the UE merely performs the non-adaptive retransmission for the data 1. In other words, the retransmission by the UE is based on the non-adaptive HARQ.

Each time the UE performs one data transmission using the HARQ scheme, the UE takes a count of the number of transmissions (CURRENT_TX_NB). If the transmission number reaches a maximum transmission number (CURRENT_TX_NB) set by an upper layer, the UE discards the MAC PDU stored in a HARQ buffer.

If the HARQ ACK for the data 1 retransmitted from the UE is received and if a UL grant is received via the PDCCH, the UE may determine whether data to be transmitted this time is an initially-transmitted MAC PDU or whether to retransmit a previous MAC PDU using a new data indicator (NDI) field received via the PDCCH. In this case, the NDI field is a 1-bit field. The NDI field is toggled as 0->1->0->1-> . . . each time a new MAC PDU is transmitted. For the retransmission, the NDI field is set to a value equal to that of the initial transmission. In particular, the UE may determine whether to retransmit the MAC PDU, by comparing the NDI field with a previously transmitted value.

In case of FIG. 10, as a value of NDI=is toggled into NDI=1, the UE recognizes that the corresponding transmission is a new transmission. The UE may transmit data 2 via a PUSCH.

As mentioned above, although the UE is configured with a DRX and the data which has been transmitted from the UE is successfully received by the base station, the UE has to monitor the PDCCH due to a possibility to receive an instruction of adaptive retransmission.

Of course, if the data is for best effort services, since the data is sensitive to packet loss, the UE is required to monitor the PDCCH for adaptive retransmission.

However, if the data is for voice services, because it does not very sensitive to packet loss, it is unnecessary for the UE to monitor the PDCCH for adaptive retransmission. For example, consider the following scenario. The UE configured with DRX transmits a voice data on uplink resource related to SPS to the eNB and receives a HARQ ACK from the eNB. Here, although the UE receives the HARQ ACK, the UE is required to monitor the PDCCH due to a possibility to receive an instruction of adaptive retransmission. The monitoring of the PDCCH is kept going until the number of retransmissions is equal to the maximum number of retransmissions thereby discarding the data in the buffer.

Hereinafter, technical ways to solve the above explained problems will be explained.

According to one embodiment, there is provided a way that the UE does not consider a duration to receive the uplink grant for the retransmission of data as an active time in order not to monitor the PDCCH, if the uplink data to be retransmitted is related to the SPS. In other words, the UE considers the duration to receive the uplink grant for the retransmission as the active time in order to monitor the PDCCH, if the uplink data to be retransmitted is not related to the SPS.

Whether the uplink data to be retransmitted is related to the SPS or not can be determined, as follows:

A first technique: The base station allocates radio resource to a UE using a semi-persistent scheduling (SPS). The UE performs a new transmission of data on the radio resource allocated by using the SPS. Then, the UE can determine that a HARQ retransmission with respect to the new transmission on the radio resource allocated by using the SPS is also related to the SPS. For example, if the UE performs a new transmission of data 1 on radio resource allocated using SPS, then the UE determines that a HARQ retransmission with respect to the new transmission on the radio resource allocated by using the SPS is also related to the SPS.

A second technique: The base station informs the UE about information on a HARQ process related to the SPS. Then, the UE can determine that a HARQ retransmission to be performed by the HARQ process indicated by the information is related to the SPS. For example, if the base station designates or indicates the HARQ process related to the SPS as an “X”, then the UE the UE can determine that a HARQ retransmission to be performed by the HARQ process indicated as “X” is related to the SPS.

In plain language, if the UE is preparing the HARQ retransmission although the UE receives an HARQ ACK with respect to the new transmission, the UE determines that the HARQ retransmission is related to the SPS. Consequently, if the UE is preparing the HARQ retransmission although the UE receives an HARQ ACK with respect to the new transmission, and thus if the UE determines that the HARQ retransmission is related to the SPS, the UE does not consider a duration to receive the uplink grant for the HARQ retransmission as an active time in order not to monitor the PDCCH.

Meanwhile, the UE can receives a configuration for specifying whether to consider a duration to receive the uplink grant for the HARQ retransmission as an active time or not for a case when the HARQ retransmission is related to the SPS.

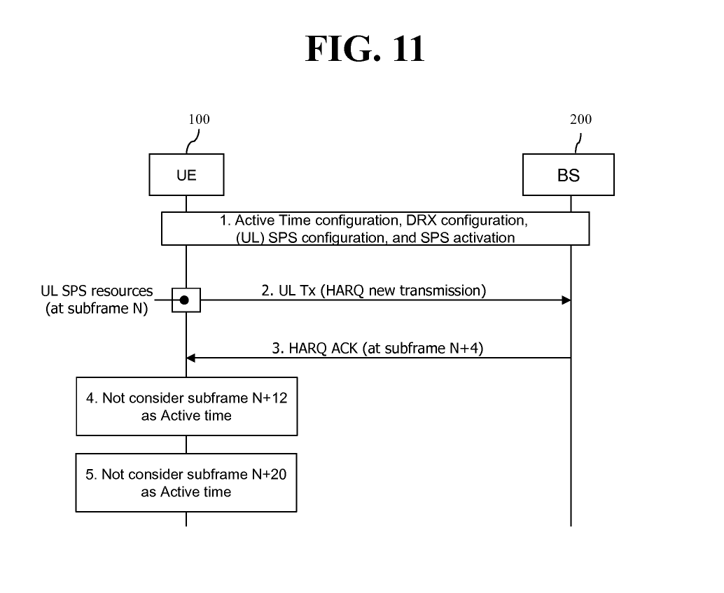

Hereinafter, technical ways to solve the above will be explained in more detail, referring to FIG. 11.

FIG. 11 shows some exemplary operation of the UE according to one embodiment disclosed in the present specification.

As shown in FIG. 11, the UE 100 receives an active time configuration, and a DRX configuration from the base station 200. The active time configuration may include a setting for allowing the UE not to consider a duration to receive the uplink grant for the retransmission of data as the active time in order not to monitor the PDCCH, if the uplink data to be retransmitted is related to the SPS.

Also, the UE 100 also receives an SPS configuration and an activation of the SPS from the base station 200. In other words, the UE 100 receives information on the uplink resource allocated based on the SPS.

The UE 100 transmits a new data at an uplink sub-frame N which is allocated based on the SPS. In other words, the UE performs a HARQ new transmission of the data by using the uplink resources allocated based on the SPS.

In response, the UE 100 receives a HARQ ACK at the sub-frame N+4 from the base station 200.

Then, the UE 100 determines whether to consider a sub-frame N+12 to receive the uplink grant for the HARQ retransmission as an active time or not. In this example of FIG. 11, the UE 100 does not consider the sub-frame N+12 as the active time since the HARQ retransmission is related to the SPS although the UE 100 has the data for the HARQ retransmission in the buffer.

Similarly, the UE 100 also determines whether to consider a sub-frame N+20 to receive the uplink grant for the HARQ retransmission as an active time or not. In this example of FIG. 11, the UE 100 does not consider the sub-frame N+20 as the active time since the HARQ retransmission is related to the SPS although the UE 100 has the data for the HARQ retransmission in the buffer.

Hereinafter, the summary about the problem in the related art and the ways to solve the problem as discussed above will be again explained for promoting understanding.

1. The Related Art

1.1 Discontinuous Reception (DRX)

The UE may be configured by RRC with a DRX functionality that controls the UE's PDCCH monitoring activity for the UE's C-RNTI, TPC-PUCCH-RNTI, TPC-PUSCH-RNTI and Semi-Persistent Scheduling C-RNTI (if configured). When in RRC_CONNECTED, if DRX is configured, the UE is allowed to monitor the PDCCH discontinuously using the DRX operation; otherwise the UE monitors the PDCCH continuously. When using DRX operation, the UE should also monitor PDCCH. RRC controls DRX operation by configuring the timers on DurationTimer, drx-InactivityTimer, drx-RetransmissionTimer (one per DL HARQ process except for the broadcast process), the longDRX-Cycle, the value of the drxStartOffset and optionally the drxShortCycleTimer and shortDRX-Cycle.

When a DRX cycle is configured, the Active Time includes the time while:

a) on DurationTimer or drx-InactivityTimer or drx-RetransmissionTimer or mac-ContentionResolutionTimer is running; or

b) a Scheduling Request is sent on PUCCH and is pending; or

c) an uplink grant for a pending HARQ retransmission can occur and there is data in the corresponding HARQ buffer; or

d) a PDCCH indicating a new transmission addressed to the C-RNTI of the UE has not been received after successful reception of a Random Access Response for the preamble not selected by the UE (as described in subclause 5.1.4).

When DRX is configured, the UE should perform for each subframe at least one or more of:

a) if a HARQ RTT Timer expires in this subframe and the data of the corresponding HARQ process was not successfully decoded, the UE starts the drx-RetransmissionTimer for the corresponding HARQ process.

b) if a DRX Command MAC control element is received, the UE stops on DurationTimer and stops drx-InactivityTimer.

c) if drx-InactivityTimer expires or a DRX Command MAC control element is received in this subframe and if the Short DRX cycle is configured, the UE starts or restarts drxShortCycleTimer and uses the Short DRX Cycle. Else, the UE uses the Long DRX cycle.

d) if drxShortCycleTimer expires in this subframe, the UE uses the Long DRX cycle.

e) If the Short DRX Cycle is used and [(SFN*10)+subframe number] modulo (shortDRX-Cycle)=(drxStartOffset) modulo (shortDRX-Cycle), or if the Long DRX Cycle is used and [(SFN*10)+subframe number] modulo (longDRX-Cycle)=drxStartOffset, the UE starts on DurationTimer.

f) During the Active Time, for a PDCCH-subframe, if the subframe is not required for uplink transmission for half-duplex FDD UE operation and if the subframe is not part of a configured measurement gap, the UE monitors the PDCCH;

And, if the PDCCH indicates a DL transmission or if a DL assignment has been configured for this subframe, the UE starts the HARQ RTT Timer for the corresponding HARQ process and stops the drx-RetransmissionTimer for the corresponding HARQ process.

And, if the PDCCH indicates a new transmission (DL or UL), the UE starts or restarts drx-InactivityTimer. Here, when not in Active Time, type-0-triggered SRS may not be reported. Or, if CQI masking (cqi-Mask) is setup by upper layers and when on DurationTimer is not running, CQI/PMI/RI/PTI on PUCCH may not be reported. Else, when not in Active Time, CQI/PMI/RI/PTI on PUCCH may not be reported.

Regardless of whether the UE is monitoring PDCCH or not, the UE receives and transmits HARQ feedback and transmits type-1-triggered SRS when such is expected.

Parenthetically, the UE may optionally choose to not send CQI/PMI/RI/PTI reports on PUCCH and/or type-0-triggered SRS transmissions for up to 4 subframes following a PDCCH indicating a new transmission (UL or DL) received in subframe n−i, where n is the last subframe of Active Time and i is an integer value from 0 to 3. After Active Time is stopped due to the reception of a PDCCH or a MAC control element a UE may optionally choose to continue sending CQI/PMI/RI/PTI reports on PUCCH and/or SRS transmissions for up to 4 subframes. The choice not to send CQI/PMI/RI/PTI reports on PUCCH and/or type-0-triggered SRS transmissions is not applicable for subframes where on DurationTimer is running and is not applicable for subframes n−i to n.

Parenthetically, the same active time applies to all activated serving cell(s).

1.2 C-RNTI MAC Control Element

The C-RNTI MAC control element is identified by MAC PDU subheader with LCID as specified in table below.

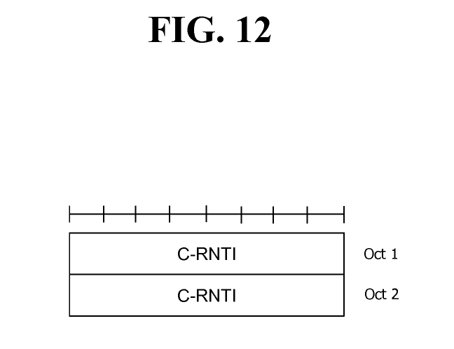

Referring to FIG. 12, the C-RNTI MAC control has a fixed size and consists of a “C-RNTI” field. This field contains the C-RNTI of the UE. The length of the field is 16 bits.

1.3 MAC Header for DL-SCH, UL-SCH and MCH

The MAC header is of variable size and consists of the following fields:
LCID field: The Logical Channel ID field identifies the logical channel instance of the corresponding MAC SDU or the type of the corresponding MAC control element or padding for the DL-SCH, UL-SCH and MCH respectively. There is one LCID field for each MAC SDU, MAC control element or padding included in the MAC PDU. In addition to that, one or two additional LCID fields are included in the MAC PDU, when single-byte or two-byte padding is required but cannot be achieved by padding at the end of the MAC PDU. The LCID field size is 5 bits;
L field: The Length field indicates the length of the corresponding MAC SDU or variable-sized MAC control element in bytes. There is one L field per MAC PDU subheader except for the last subheader and subheaders corresponding to fixed-sized MAC control elements. The size of the L field is indicated by the F field;
F field: The Format field indicates the size of the Length field. There is one F field per MAC PDU subheader except for the last subheader and subheaders corresponding to fixed-sized MAC control elements. The size of the F field is 1 bit. If the size of the MAC SDU or variable-sized MAC control element is less than 128 bytes, the value of the F field is set to 0, otherwise it is set to 1;
E field: The Extension field is a flag indicating if more fields are present in the MAC header or not. The E field is set to “1” to indicate another set of at least R/R/E/LCID fields. The E field is set to “0” to indicate that either a MAC SDU, a MAC control element or padding starts at the next byte;
R field: Reserved bit, set to “0”.

The MAC header and sub-headers are octet aligned.

Values of LCID for DL-SCH are shown in table 1 below.

TABLE 1

| Index | LCID values |
|---|---|
| 00000 | CCCH |
| 00001-01010 | Identity of the logical channel |
| 01011-11010 | Reserved |
| 11011 | Activation/Deactivation |
| 11100 | UE Contention Resolution Identity |
| 11101 | Timing Advance Command |
| 11110 | DRX Command |
| 11111 | Padding |

As above explained, in the conventional DRX operation, the UE is active for receiving adaptive UL retransmission grants until the corresponding HARQ buffer is flushed. The UE is active even after a positive HARQ acknowledgement (HARQ ACK) is received by the UE as a response to an uplink transmission.

There are some reasons why it is beneficial to monitor PDCCH even an HARQ ACK is received: Firstly, there might be NACK-to-ACK errors in the HARQ feedback. The network can find this error from detecting missing UL retransmission and let that trigger a new retransmission one HARQ RTT later. Secondly, the network may suspend the UL retransmission with a HARQ ACK. This could be done, e.g., when radio resources need to be allocated for another UE having higher priority traffic (e.g. Msg3).

1.4 Problems in the Related Art

However, it is also important to consider power efficiency of the current approach. In some scenarios, PDCCH monitoring due to retransmission grants forms the major part of the DRX Active time. Let us assume the following example: There is a voice conversation ongoing (one speaker is silent). The VoIP packets are transmitted in uplink direction every 20 ms. The UE is scheduled with a Semi-Persistent grant every 20 ms as well. At the minimum, the UE needs to be active 1 ms for UL transmission and n ms for adaptive retransmission grants, where n corresponds to the maximum number of UL HARQ retransmissions. In a typical case, n is 4. This means that if the UE receives a HARQ ACK already for the initial UL transmission, it needs to be active for another 3 ms, which results in a 300% increase in power consumption as compared to the case where the UE can go to sleep after receiving an ACK.

2. Ways to Solve the Problem

In this specification, the time that an uplink grant for a pending HARQ retransmission can occur and there is data in the corresponding HARQ buffer is not included in the Active Time if the HARQ retransmission is associated with the semi-persistent scheduling. Therefore, the UE is not required to monitor the PDCCH at that time.

For association with SPS, the following options are possible.

If the eNB informs the UE of the associated HARQ processes, the UE determines that HARQ retransmissions of the informed HARQ processes are associated with the semi-persistent scheduling.

Alternatively, if the new transmission is performed on the configured resources (i.e., SPS resources), the UE determines that the corresponding HARQ retransmissions are associated with the semi-persistent scheduling.

If the association is configured to the UE, when an uplink grant for a pending HARQ retransmission can occur and there is data in the corresponding HARQ buffer, the UE checks whether the HARQ retransmission is associated with the semi-persistent scheduling.
if the HARQ retransmission is associated with the semi-persistent, the UE shall monitor the PDCCH.
Else, the UE is not required to monitor the PDCCH.

To implement this, the following changes for the specification are possible.

When a DRX cycle is configured, the Active Time includes the time while:

a) on DurationTimer or drx-InactivityTimer or drx-RetransmissionTimer or mac-ContentionResolutionTimer is running; or

b) a Scheduling Request is sent on PUCCH and is pending; or

c) if the PDCCH monitoring for SPS is not setup, an uplink grant for a pending HARQ retransmission can occur and there is data in the corresponding HARQ buffer; or

d) if the PDCCH monitoring for SPS is setup, an uplink grant for a pending HARQ retransmission can occur, the new transmission was not performed on the configured resources, and there is data in the corresponding HARQ buffer; or

e) a PDCCH indicating a new transmission addressed to the C-RNTI of the UE has not been received after successful reception of a Random Access Response for the preamble not selected by the UE.

The ways or methods to solve the problem of the related art according to the present disclosure, as described so far, can be implemented by hardware or software, or any combination thereof.

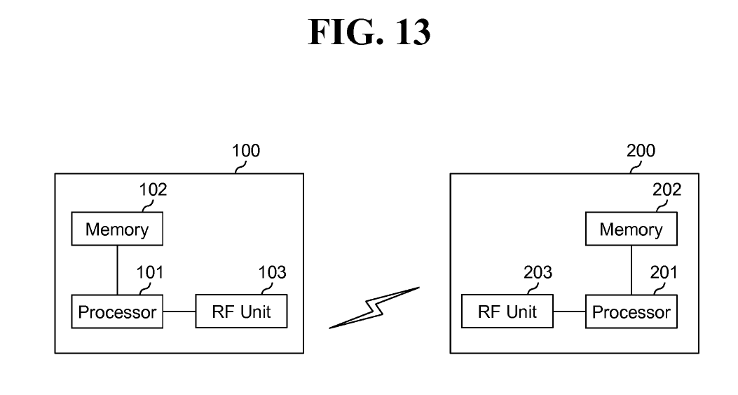

FIG. 13 is a block diagram showing a wireless communication system to implement an embodiment of the present invention.

An UE 100 includes a processor 101, memory 102, and a radio frequency (RF) unit 103. The memory 102 is connected to the processor 101 and configured to store various information used for the operations for the processor 101. The RF unit 103 is connected to the processor 101 and configured to send and/or receive a radio signal. The processor 101 implements the proposed functions, processed, and/or methods. In the described embodiments, the operation of the UE may be implemented by the processor 101.

A BS 200 includes a processor 201, memory 202, and an RF unit 203. The memory 202 is connected to the processor 201 and configured to store various information used for the operations for the processor 201. The RF unit 203 is connected to the processor 201 and configured to send and/or receive a radio signal. The processor 201 implements the proposed functions, processed, and/or methods. In the described embodiments, the operation of the BS may be implemented by the processor 201.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

1. A monitoring method according to a discontinuous reception (DRX), the method comprising:
determining whether an uplink data to be retransmitted is related to a semi-persistent scheduling (SPS); and
monitoring a physical downlink control channel (PDCCH) to receive an uplink grant for the retransmission if the uplink data to be retransmitted is not related to the SPS, or
not monitoring the PDDCH, if the uplink data to be retransmitted is related to the SPS.

2. The method of claim 1, wherein in the determination
if an initial transmission of the uplink data was performed on a resource configured for the SPS, it is determined that the uplink data to be retransmitted is related to the SPS.

3. The method of claim 1, wherein in the determination,
if the SPS is not setup, it is determined that the uplink data to be retransmitted is not related to a SPS.

4. The method of claim 1, wherein in the determination,
wherein if an initial transmission of the uplink data was performed on a resource which is not configured for the SPS, it is determined that the uplink data to be retransmitted is not related to a SPS.

5. The method of claim 1, further comprising:
performing an initial transmission of the uplink data.

6. The method of claim 1, further comprising:
determining whether the uplink data to be retransmitted is pending in a buffer.

7. The method of claim 1, wherein the monitoring step includes:
considering a duration to receive the uplink grant for the retransmission as an active time in order to monitor the PDCCH, if the uplink data to be retransmitted is not related to the SPS.

8. The method of claim 1, wherein the not monitoring step includes:
not considering a duration to receive the uplink grant for the retransmission as an active time in order not to monitor the PDCCH, if the uplink data to be retransmitted is related to the SPS.

9. A communication device configured for monitoring physical downlink control channel (PDCCH) based on a discontinuous reception (DRX), the communication device comprising:
a processor configured to determine whether an uplink data to be retransmitted is related to a semi-persistent scheduling (SPS); and
a radio frequency unit configured to monitor a physical downlink control channel (PDCCH) to receive an uplink grant for the retransmission if the uplink data to be retransmitted is not related to the SPS, or not monitor the PDDCH, if the uplink data to be retransmitted is related to the SPS.

10. The communication device of claim 9, wherein
if an initial transmission of the uplink data was performed on a resource configured for the SPS, the processor determines that the uplink data to be retransmitted is related to the SPS.

11. The communication device of claim 9, wherein
if the SPS is not setup, the processor determines that the uplink data to be retransmitted is not related to a SPS.

12. The communication device of claim 9, wherein
if an initial transmission of the uplink data was performed on a resource which is not configured for the SPS, the processor determines that the uplink data to be retransmitted is not related to a SPS.

13. The communication device of claim 9, wherein the RF unit is further configured to perform an initial transmission of the uplink data.

14. The communication device of claim 9, wherein the processor is further configured to determine whether the uplink data to be retransmitted is pending in a buffer.

15. The communication device of claim 9, wherein the processor is further configured to consider a duration to receive the uplink grant for the retransmission as an active time in order for the RF unit to monitor the PDCCH, if the uplink data to be retransmitted is not related to the SPS.

16. The communication device of claim 9, wherein the processor is further configured not to consider a duration to receive the uplink grant for the retransmission as an active time in order for the RF unit not to monitor the PDCCH, if the uplink data to be retransmitted is related to the SPS.
